(19) United States
(12) Patent Application Publication
(10) Pub. No.: US 2004/0212680 A1
(43) Pub. Date: Oct. 28, 2004

(54) Device for determining a location-dependent intensity profile and color profile and/or sharpness profile of optical lens system

(76) Inventors: Sebastia Wernher Schroeder, Braunschweig (DE); Detlef Grosspietsch, Odenthal (DE); Wilfried Donner, Bielefeld (DE); Christian Wohler, Heroldstadt (DE)

Correspondence Address: BROWDY AND NEIMARK, P.L.L.C., 624 NINTH STREET, NW, SUITE 300, WASHINGTON, DC, 20001-5303, US

(21) Appl. No.: 10/479,244

(22) PCT Filed: May 28, 2002
(86) PCT No.: PCT/EP02/05859

(30) Foreign Application Priority Data
May 30, 2001 (DE) 10126546.8

(51) Int. Cl. H04N 17/00

(52) U.S. Cl. 348/188

(57) ABSTRACT

The invention is concerned with a device for determining an intensity and/or color and/or sharpness profile in each case of an optical lens system (3), which projects a test pattern (1) consisting of measuring fields (5), wherein the projection is directed indirectly or directly in each case toward a sensor area (6) of electronic color and brightness sensors of high resolution, whose measured signals, which are correlated to the measuring fields (5), are sent to a computer (60), which determines from these the intensity and/or color and/or sharpness profile and/or distortion propagation profile, outputs them to an image processing system (62) for an electronic image flaw correction of images (B) that were generated by an identical lens system (3), and stores them or temporarily stores them on a data carrier (61).

The invention is concerned with a device and a process for determining a spatially-dependent intensity and color profile and/or sharpness profile and/or distortion propagation profile of optical lens systems with a test pattern and optical measuring field array.

A conventional device comprises a test pattern, e.g., a television test pattern, wherein the test pattern comprises individual measuring fields, which are distributed across the test pattern and relatively large in size, suitable in each case for the evaluation of only the sharpness, or color, or intensity.

The shortcoming of this device is that no spatial resolution is possible because the test pattern consists of large individual measuring fields, which are suitable in each case for the evaluation of only the sharpness, or color, or intensity.

It is the object of the invention to create a device and a process that provide a complete quality assessment of an image field of a lens system and in the process deliver correction data for electronic image enhancement, which are to be made available for image processing on a data carrier or in a processor.

This problem is solved according to the invention with the device according to claim 1.

A solution of the problem according to the inventive process is specified in claims 24-39.

Data storage media with stored test pattern data and data storage media with correction data that were produced by the device are additional subject matters of the invention.

Advantageous improvements of the invention are specified in the subclaims.

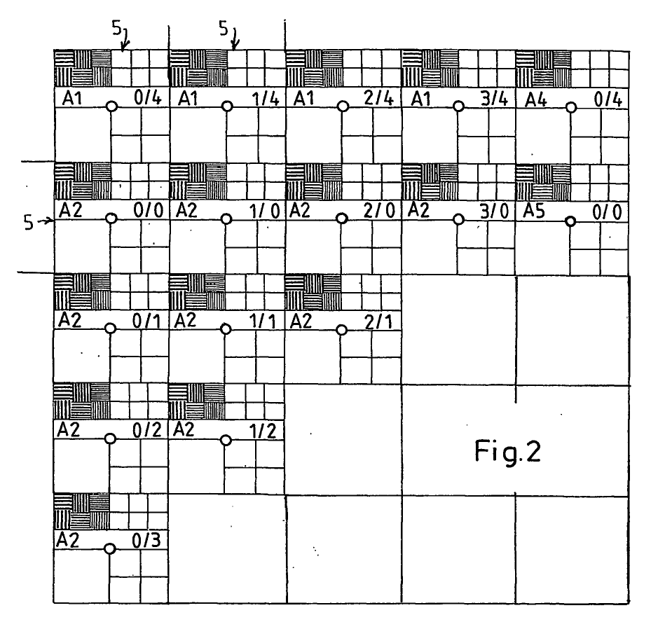

Alternatively, a measured-sharpness number is determined using an analysis of the distribution of the gray scale values in the measuring field. The line structures in a test pattern, e.g., the one shown in FIG. 2, which are projected onto the sensor area, yield a high variance of gray scale values if the image sharpness is high and a low variance if the sharpness is low. It is beneficial to fit the gray scale distribution with a single-mode distribution function containing at least one parameter in each case that characterizes the maximum of distribution, as well as at least one parameter in each case that characterizes the width of distribution. A Gaussian function with the mean value and variance for the measured gray scale values of the line structure is used for this purpose, for example.

In an improvement of the determination of the measured-sharpness number, a multi-mode distribution function is fit to each measured gray scale distribution, which is particularly advantageous if the latter features several maxima.

A distribution function having at least one parameter that characterizes the mean value of the maximum, as well as one parameter that characterizes the width of the maximum is fit to each maximum. Altogether a sum of several Gaussian functions is attained, each of which describes a mean value and a variance; see “Mixture of Gaussians”, C. M. Bishop, Neural Networks of Pattern Recognition; Clarendon Press, Oxford, 1995. A low variance corresponds to a high image sharpness and a high variance corresponds to a low image sharpness.

The invention will be described below with the aid of various embodiments with reference to a drawing in which:

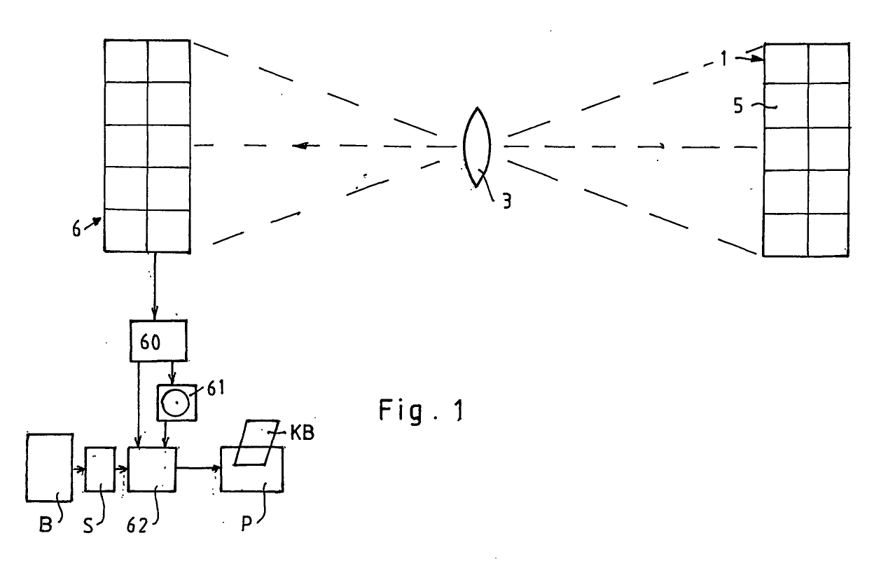

FIG. 1 shows a device with a lens system and a test pattern, as well as an image of the test pattern on a sensor area to which a device for analysis is connected.

FIG. 2 shows a test pattern according to the invention; and

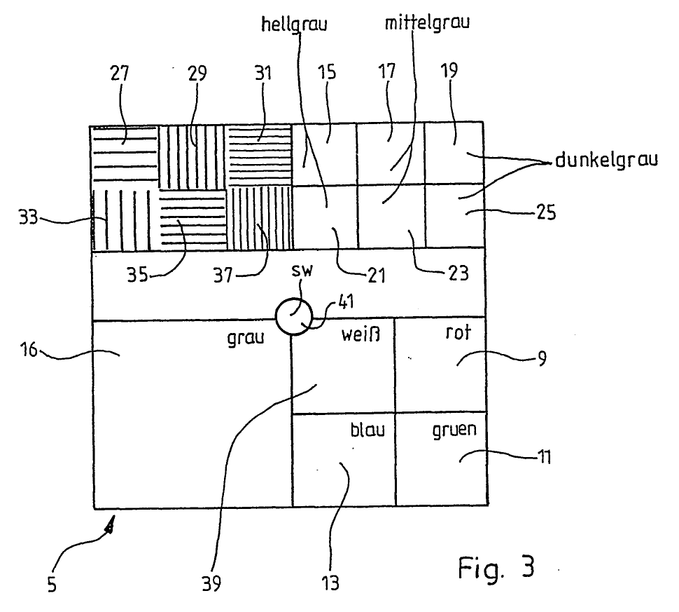

FIG. 3 shows a measuring field of the test pattern.

A preferred embodiment will be described below.

An inventive device in FIG. 1 comprises a test pattern 1, which is imaged in each case onto a sensor area 6 using an optical lens system 3, which is to be measured. The image of the test pattern 1 may be provided on a monitor or photograph. The test pattern is imaged with the optical lens system 3, whose profile(s) is (are) to be created, at a certain aperture setting, even illumination of the test pattern, and plane-parallel setup of the camera relative to the test pattern at a certain image scale.

The image 6 can be acquired directly by the sensor area of an electronic camera or sent, as a photograph, to a scanner. The electronic image signals of the camera or scanner are sent to a computer 60, which determines, using appropriate software programs, the distribution of the sharpness, intensity, and colors of the test patterns that are distributed in a grid pattern across the image 6. These distributions are organized into profiles, which are transferred, either directly or after temporary storage on a data carrier 61, to an image processing system 62.

The image processing system 62 may be located within a camera that is equipped with the lens system 3 itself or with an identical lens system. It is also possible, however, to load images B from such a camera or via a scanner into the processing system 62, into which the profiles are loaded, and which, with the aid of these profiles, produces corrected image data from which the image flaws have been removed, which are printed as a corrected image KB on a printer P. It is thus possible to produce corrected high-quality images using cameras with simple lens systems.

The sensor means of the image of the test pattern must feature a sufficiently high resolution of the intensity and lines or areas (pixels), so that the imaged test patterns are completely resolved in each case.

The test pattern in FIG. 2 features a plurality of identical measuring fields, which are only partially completed in the figure, which are arranged preferably periodically in both dimensions of a test pattern. Each measuring field comprises measuring cells, which are shown in detail in FIG. 3, by means of which the intensity, color, and sharpness in the area of each individual measuring field can be measured (so-called color, intensity, and sharpness-measuring cells). Consequently the intensity, color, and sharpness in the given measuring cell of the measuring field can be measured for every area of the distributed measuring fields 5, as a result of which the precision of the generated intensity and color profiles and/or sharpness profiles depends directly on the size of the measuring field.

With regard to color:

Typical imaging systems (e.g., monitors, televisions, and photographs) display all the colors visible to man. This is usually accomplished by mixing the three primary colors, i.e., the basis for the color space, typically red, yellow and blue, in different intensities. Generally it is possible, however, to select any desired basis for the color space visible to man. Through the choice of different intensities of each primary color, i.e., different color values in the color space, it is possible to display all colors visible to man. To be able to generate a suitable color profile of the measuring field, the measuring field comprises measuring cells, which are each filled with one primary color. To match the test pattern to most of the known imaging systems, the colors red, green and blue are preferably used as the primary colors. Furthermore, the measuring field comprises gray measuring cells in order to be able to determine spatially-dependent discolorations of the lens system.

With regard to intensity:

To determine the intensity within a measuring field, no separate measuring cells are provided within the measuring field. Instead, the image of the test pattern is used to determine the intensity in the area of the measuring field. A suitable mean value of the color values of the primary colors of each measuring field is calculated for this purpose, or at least one gray measuring cell of a known gray value is used.

With regard to sharpness:

To determine the sharpness, the measuring field comprises measuring cells that are each filled with a line pattern with different line densities. The line patterns of neighboring measuring cells preferably exhibit different orientations. Furthermore, in a preferred embodiment, the measuring field comprises an edge transition, in the present case a black-white edge transition.

The given measuring cells are advantageously completely filled with the given object to be measured, i.e., the “blue” measuring cell, for example, is advantageously completely filled with blue.

The device with the test pattern, which has measuring fields that are preferably periodically arranged in both dimensions of the test pattern and wherein each measuring field has different measuring cells (intensity and color and/or sharpness measuring cells) and which has an optical lens system as well as a device for measuring the color values and determining the sharpness, particularly a CCD camera with an attached computer, or a scanner with a computer for scanning in a test pattern projection of the lens system, serves to perform a process for determining a spatially-dependent intensity and color profile and/or sharpness profile of the optical lens system.

In a first step of the process, the positions of all measuring fields in the image of the test pattern are identified.

In a second step the sharpness profile is created as follows: First, a measuring cell with maximum sharpness is determined in a partial step; in an additional partial step the parameters Pⱼ(xᵢ,yᵢ) are determined for each sharpness-measuring cell, in order to approximate the measured-sharpness number Sⱼ(xᵢ,yᵢ) of each measuring cell to that of the reference cell for sharpness, and in a third partial step a continuous sharpness profile is created by interpolation between the sharpness measuring cells.

In a third step for determining an intensity profile and color profile, a number of primary colors (the basis for the color space) are imaged by the optical lens system in a first partial step; in a second partial step the given intensity and color value is measured for each intensity-measuring and color-measuring cell of the image of the test pattern in the given color space; in a third partial step, the measuring cell with the maximum color or intensity value in each case is used as a reference cell; in a fourth partial step, a correction factor for each primary color and intensity is calculated for each measuring field, referenced to the corresponding reference value; and in a fifth partial step, a complete intensity and color profile is created through interpolation between the results from the intensity-measuring or color-measuring cells. This process can also be applied separately for each color plane, as well as separately for radial or tangential image structures.

The step for generating the intensity and color profile and that for generating a sharpness profile can be executed separately from one another and they are therefore in principle interchangeable. It is thus not imperative to create both profiles, or to create one before the other.

The identification of the position of all measuring fields in the image of the test pattern, in the simple case, takes place with an undistorted image of the test pattern. In this case at least three points in the image are used which correspond to known positions in the master pattern to calculate the orientation and image scale of the image. The position of all intensity and color and/or sharpness measuring cells in the image of the test pattern is thus known.

If a distortion is present in the image of the test pattern, as it can appear, e.g., as a result of a flawed lens or in the vicinity of the edge of the objective, a distortion coefficient has to be determined whereby the distortion can be eliminated computationally from the image. The distortion coefficient is calculated based on points in the image that correspond to known positions of the test pattern. In general it can be assumed that the distortion coefficient is not constant for all positions in the test pattern. It is therefore advantageous to calculate it at different positions of the test pattern or of the image of the test pattern, if necessary taking into account the symmetry of the lens system. In this manner the corresponding point in the image of the test pattern is calculated for every point of the test pattern and, as a result, so are the positions of all intensity and color and/or sharpness-measuring cells in the image of the test pattern.

When determining the sharpness profile of the lens system, the measuring field with the maximum sharpness, the so-called reference field for sharpness, is first determined in the second step. This measuring field can be determined through visual inspection on the one hand, i.e., by the user himself, and on the other hand with the aid of an automatic process.

A quantitative process for the determination of the degree of sharpness of a measuring field is, e.g., a gradient process in the intensity space whereby I₍ₓ₎ is the intensity of an image pixel x of a row or column of image pixels x=1, . . . , N, which cover an intensity edge within the test pattern. A measured-sharpness number S then amounts to the maximum gradient for the interval x=1, . . . , N for S=max(dI₍ₓ₎/dx). As in most processes, however, a measured-sharpness number is determined

for each measuring field, with the measuring field with the highest measured-sharpness number being used as a reference field for sharpness. From German patent document DE 44 13 368, an automatic process for determining the measured-sharpness number is known, which uses a discrete amplitude spectrum A_{(f)}, f=1, . . . , N/2 on a row or column of image pixels x=1, . . . , N. A measured-sharpness number S then amounts to the integral over the high-frequency coefficients of the amplitude spectrum, e.g., using

$$S = {\sum }_{{f}_{o}}^{N / 2} {A}_{( f )}$$

preferably with fₒ=N/4 or fₒ=N/8.

Once the reference field for sharpness is determined, a computational method is required to enhance the sharpness of an image or to adjust the measured-sharpness numbers of all measuring fields toward that of the reference field for sharpness.

Initially, these processes may also be used to determine a measured-sharpness number by themselves, particularly if the reference field for sharpness was determined through visual inspection. In this context the parameters Pⱼ, which are to be varied in the process and which, after variation of the same, yield the best approximation of the measured-sharpness number of the measuring field to the measured-sharpness number of the reference field for sharpness, are themselves viewed as a measured-sharpness number.

A process, as part of which a parameterized correction function in the spatial frequency space is used will be described here by way of example. This function K_{(f)} with f as the spatial frequency is an arbitrary function, which generally increases monotonically with f, preferably K_{(f)}=(1+af)^{v} with a and v as parameters, especially v=2. The frequency spectrum of each measuring field is matched to that of the reference field, with those parameters that provide the best agreement serving as a measured-sharpness number.

A process for masking unsharpness, which implicitly also uses a correction function K_{(f)} in the spatial frequency space, may be used as a computational process for enhancing the image sharpness in the second partial step of the second step. However, generally the radius of the mask and the intensity are used as parameters.

The values determined so far are discrete, i.e., they are referenced to a certain measuring field. In order to obtain a continuous profile, interpolation is necessary. This may be accomplished, e.g., in the third partial step by interpolating the parameters Pⱼ (xᵢ, yᵢ) to parameters Pⱼ (x, y) or, in the second partial step of the third step, through bi-linear or bi-cubic interpolation.

The generated intensity and color profiles and/or sharpness profiles are used to improve the quality of images that were generated with the same or an identical optical lens system.

In the case of digital cameras, this can be accomplished, e.g., by storing the profiles for the camera within the camera and enhancing the image with the aid of the profiles, preferably automatically. The profiles can, on the other hand, also be stored in a post-processor in order to save storage space in the camera, and the images can be enhanced with the aid of the profiles during the download from

the camera, preferably automatically. The profiles may, however, also be used to enhance scanned-in images. The digital image that is present in the computer is enhanced with the profiles that are associated with the lens system that was used to produce the image. The required profiles can be stored on any data carrier.

FIG. 3 shows an enlargement of measuring field 5. Line patterns are arranged in two rows with a number of lines that increases by about a factor of 1:1.5 in each case at a correspondingly decreasing line width. In the first row, the lines in the measuring cells 27, 29, 31 are oriented alternatingly vertically and horizontally and in the second row, in the measuring cells 33, 35, 37, they are oriented correspondingly perpendicular to them. It is thus possible to determine the frequency components along both axes. The additional cells 15, 17, 19, 21, 23, and 25 are gray cells with different predefined gray levels, light gray, medium gray, and dark gray.

The center of the measuring field 5 is covered with a black circle 41 as a positioning aid. A quadrant 16 of the measuring field 5 features a defined gray scale, which serves as a brightness reference. The last quadrant of the measuring field is covered with one each white measuring cell 39, red measuring cell 9, green measuring cell 14, and blue measuring cell 13, which are used for color measurements

In a different step of the process it is also possible to determine from the measured signals, based on the evaluation of the projection of the known test pattern 5 onto the measuring field 6, a distortion propagation profile, with the aid of which the restitution of corresponding images can take place. The respective position of the centering points 41 in the test pattern is known, so that determining the position of the images of the centering points 41 reflects any distortions. Beginning with the

position of the outermost centering points, the desired positions of the other centering points within the known grid must be determined. Together with the actual positions that were measured in each case, the distortion is obtained based on the deviations in the individual reference locations. The interpolated compilation of the distortion values represents the distortion propagation profile.

The distortion propagation profile may be used for processing images that were similarly projected through the same objective, in the same way as the sharpness profile or the color propagation profile.

The corrections or partial corrections of the individual propagations are of course not bound to a certain sequence, however is possible that in individual cases advantageous differences in the result may be obtained for a certain sequence as compared to others.

List of Reference Numerals:

1 Test pattern

3 Optical lens system

5 Measuring field

6 Sensor area with image

60 Computer

61 Data carrier

62 Image processing system

7 Measuring cell

9 Red measuring cell

11 Green measuring cell

13 Blue measuring cell

15, 16, 17, 19, 21, 23, 25 Gray measuring cell

27, 29, 31, 33, 35, 37 Measuring cell with line pattern

39 White measuring cell

41 Black circle

43 Image of the test pattern

B Image

S Scanner

P Printer

KB Corrected image

Translations for FIG. 3/3:

hellgrau—light gray

mittelgrau—medium gray

dunkelgrau—dark gray

grau—gray

weiβ—white

rot—red

blau—blue

gruen—green

Ersatzblatt (Regel 26)—Replacement page (Rule 26)

1. A device for determining an intensity and/or color and/or sharpness profile in each case of an optical lens system (3), which projects a test pattern (1) consisting of measuring fields (5), wherein the projection is directed indirectly or directly in each case toward a sensor area (6) of electronic color and brightness sensors of high resolution, whose measured signals, which are correlated to the measuring fields (5), are sent to a computer (60), which determines from these the intensity and/or color and/or sharpness profile and/or distortion propagation profile, outputs them to an image processing system (62) for an electronic image flaw correction of images (B) that were generated by an identical lens system (3), and stores them or temporarily stores them on a data carrier (61).

2. A device according to claim 1, characterized in that the measuring field (5) incorporates different measuring cells (9, 11, 13, through 39), namely intensity measuring cells (15, 16, 17, 19, 21, 25, 39, 41) for a measurement of intensity, and color measuring cells (9, 11, 13, 39) for the measurement of color, and/or sharpness measuring cells (27, 29, 31, 33, 37) for the measurement of sharpness.

3. A device according to claim 2, characterized in that the color measuring cells (9, 11, 13) are filled with colors, preferably with a different primary color (red, green, blue) in each case.

4. A device according to claim 1, characterized in that the measuring field (5) comprises at least one gray intensity measuring cell (16).

5. A device according to claim 4, characterized in that the measuring field (5) comprises intensity measuring cells (15, 16, 17, 19, 25, 29, 41) with different gray scale values, as well as white and black.

6. A device according to claim 1, characterized in that the measuring field (5) comprises at least one sharpness measuring cell (27, 29, 31, 33, 35, 37) with a line pattern.

7. A device according to claim 6, characterized in that that measuring field (5) incorporates sharpness measuring cells (27, 29, 31, 33, 35, 37) with line patterns of different line density and with different orientations.

8. A device according to claim 1, characterized in that the measuring fields (5) are imaged in different brightness levels on the test pattern (1).

9. A device according to claim 1, characterized in that the measuring field comprises white measuring cells (39).

10. A device according to claim 1, characterized in that the measuring field (5) comprises a (color)-edge transition, especially one from black (39) to white (37).

11. A device according to claim 1, characterized in that the measuring fields (5) fill the test pattern (1) completely.

12. A device according to claim 1, characterized in that the measuring fields (5) are arranged in rows.

13. A device according to claim 1, characterized in that the measuring fields (5) are arranged in columns.

14. A device according to claim 12, characterized in that the measuring fields (5) touch one another.

15. A device according to claim 12, characterized in that that measuring fields (5) are arranged such that a matrix of measuring fields is formed.

16. A device according to claim 1, characterized in that the measuring cells (9 through 39) completely fill the measuring field (5).

17. A device according to claim 1, characterized in that the measuring cells (9 through 39) are arranged in rows in the measuring field (5).

18. A device according to claim 1, characterized in that the measuring cells (9 through 39) are arranged in columns in the measuring field (5).

19. A device according to claim 17, characterized in that the measuring cells (9 through 39) touch one another.

20. A device according to claim 17, characterized in that the measuring cells (9 through 39) are arranged within the measuring field (5) such that a matrix of measuring cells is formed.

21. A test pattern with measuring fields (5) for use in the device according to claim 1.

22. A test pattern according to claim 21, characterized in that it is stored on a data carrier for reproduction on a color printer.

23. A data carrier, camera, or post-processor according to claim 1, characterized in that, in it or on the data carrier (61), the generated intensity and/or color and/or sharpness profile is stored for at least one lens system (3).

24. A process for determining a spatially-dependent intensity and color profile and/or sharpness profile of optical lens systems with a device according to claim 1, with a test pattern (1) and an optical lens system (3), wherein the test pattern comprises measuring fields (5), which are arranged in both dimensions of the test pattern, wherein the measuring field (9-39) incorporates intensity and color and/or sharpness measuring cells and is projected onto a sensor area (6) comprised of intensity and color measuring cells, whose sensor signals are evaluated in such a way that
I. in a first step, a determination takes place of the position of all intensity and color and/or sharpness measuring cells (9-39) in the image of the test pattern (1),
II. in an additional step, a determination of the sharpness profile takes place in such a way that
(a) a measured-sharpness number is determined for all sharpness measuring cells and the sharpness measuring cell with maximum sharpness is determined as a reference cell for sharpness,
(b) parameters Pⱼ (xᵢ, yᵢ) are determined for each sharpness measuring cell and the measured-sharpness number Sⱼ (xᵢ,yᵢ) of each sharpness measuring cell is compared with the reference cell for sharpness, and a correction factor is generated in the process,
(c) a continuous sharpness profile is determined through interpolation between the measured-sharpness numbers of the sharpness measuring cells and/or
III. a determination of an intensity profile and color profile is carried out in a third step, in such a way that
(a) a number of primary colors, as a basis for the color space, is imaged by the optical lens system (3),
(b) the intensity and color value within each color space is measured for each intensity and color measuring cell of the image (6) of the test pattern,
(c) the measuring cell with the maximum measured color or intensity value in each case is declared as the reference cell,
(d) for each measuring cell a correction factor is calculated for each primary color and intensity, referenced to the corresponding reference value, and
(e) a complete intensity and color profile is calculated through interpolation between the measured values of the intensity and color measuring cells.

25. A process according to claim 24, characterized in that in the first step I, in the case of an undistorted image (6) of the test pattern (1), at least three points in the image (6), which correspond to known positions in the test pattern (1), are used metrologically to determine an orientation and an image scale of the image (6), and to thereby determine the positions of the intensity measuring cells and color and/or sharpness measuring cells (9-39) in the image (6) of the test pattern (1).

26. A process according to claim 24, characterized in that, in the first step I, in the case of a distorted image of the test pattern, a distortion coefficient is calculated based on measured values from sensor areas at points in the image (6) that correspond to known positions in the test pattern (1) in such a way that, at different positions, taking into account the symmetry of the optical system, every point of the test pattern (1) is computed through to the corresponding point in the image (6) thereof and the position of all intensity and color and/or sharpness measuring cells (9-39) in the image of the test pattern (1) is thereby determined.

27. A process according to claim 24, characterized in that in step IIa a reference field for sharpness is determined through visual inspection and entered into the measured-value processing device (60).

28. A process according to claim 24, characterized in that in step IIa a measured-sharpness number Sⱼ (xᵢ, yᵢ) is automatically computationally determined for each sharpness measuring cell and the sharpness measuring cell with the maximum measured-sharpness number is used as a reference point for sharpness.

29. A process according to claim 28, characterized in that in step IIa, a degree of sharpness of a measuring cell is determined quantitatively in the intensity space using a gradient process in such a way that a row or a column of image pixels I₍ₓ₎, x=1, . . . , N, which cover an intensity edge in the image of the test pattern, yields the measured-sharpness number S as the maximum gradient (dS/dx) for this interval x=1, . . . , N for S=max (dI₍ₓ₎/dx).

30. A process according to claim 29, characterized in that in step IIa the degree of sharpness of a measuring cell is quantitatively determined by forming an integral over the high-frequency coefficients of the amplitude spectrum, specifically
$$S = {\sum }_{{f}_{o}}^{N / 2} {A}_{( f )}$$
with a column or row I₍ₓ₎, x=1, . . . , N of image pixels, a discrete amplitude spectrum A_{(f)}, f=1, . . . , N/2 of I₍ₓ₎, and the measured-sharpness number S, preferably with fₒ=N/4 or fₒ=N/8.

31. A process according to claim 30, characterized in that in step IIa or IIb the degree of sharpness of a measuring cell is determined quantitatively by matching the frequency spectrum of the given measuring field to that of the reference field with a parameterized correction function in the spatial frequency space, wherein those parameters that yield the best agreement are used as a measured-sharpness number.

32. A process according to claim 24, characterized in that in step IIb an unsharpness masking is performed in order to computationally enhance the image sharpness.

33. A process according to claim 24, characterized in that in step IIb a computational enhancement of the image sharpness is performed using a correction function in the spatial frequency space, particularly through the function k_{(f)}=(1+af)^{v} with f as spatial frequency and a and v as parameters, preferably with v=2.

34. A process according to claim 24, characterized in that in step IIc the continuous sharpness profile is calculated through an interpolation of the parameters Pⱼ (xᵢ,yᵢ).

35. A process according to claim 24, characterized in that in step IIc and/or IIIe a bi-linear interpolation is used as the interpolation process.

36. A process according to claim 24, characterized in that in step IIc and/or IIIe a bi-cubic interpolation is used as the interpolation process.

37. A process according to claim 24, characterized in that in step IIIb the intensity of the illumination of the individual measuring field (5) in the test pattern (1) is determined through a suitable mean value of the color values of the primary colors in the corresponding sensor area.

38. A process according to claim 1, characterized in that the measured-sharpness number is determined by matching to a propagation of measured gray scale values of projected line structures of a single-mode or multi-mode distribution, which features at least one parameter that characterizes a maximum of distribution and at least one parameter that characterizes the width of distribution, wherein a large width is associated with a low measured-sharpness number and a small width is associated with a larger measured-sharpness number.

39. A process according to claim 1, characterized in that from the measuring signals of the measuring field (6), an actual position of the individual centering points (41) or individual other image parts is determined in each case, whose associated positions in the projected test pattern (5) are known in each case, which are to be associated to a fictitious and distortion-free desired position in the measuring field, and that given deviations of the actual and desired positions are compiled interpolated as a distortion propagation profile.
